(19) United States
(12) Patent Application Publication
(10) Pub. No.: US 2016/0035243 A1
(43) Pub. Date: Feb. 4, 2016

(54) PORTABLE HEALTH ACTIVITY TRACKING DEVICE

(71) Applicant: Venkata Rajamannar Madabhushi, Cincinnati, OH (US)

(72) Inventor: Venkata Rajamannar Madabhushi, Cincinnati, OH (US)

(73) Assignee: HUMANA INC., Louisville, KY (US)

(21) Appl. No.: 13/038,973

(22) Filed: Mar. 2, 2011

Related U.S. Application Data
(60) Provisional application No. 61/309,691, filed on Mar. 2, 2010.

(51) Int. Cl. G09B 19/00; G09B 5/02

(52) U.S. Cl. CPC G09B 19/00; G09B 5/02

(57) ABSTRACT

A portable electronic device that assists in the maintenance of a healthy lifestyle by recording biometric measurement data, confirming completion of healthy activities, and generating graphs from biometric measurement data. The device may comprise a speaker for providing instructions to users as to how the portable device is to be used, results of biometric measurements, counting down the time remaining until a biometric measurement has been obtained, etc. The device may connect to a remote computer of a health care facility, health care provider, or insurance provider. Completion data for health activities is recorded. As the user completes measurements or other health activities such as appointments, the third party may provide a code for the user to record in the device to signal completion of the activity. The device may also be used to record data related to a user's participation in a rewards program.

### CROSS-REFERENCE TO RELATED APPLICATIONS

This application claims priority to U.S. Provisional Patent Application Ser. No. 61/309,691, filed Mar. 2, 2010, titled PORTABLE BIOMETRIC MEASUREMENT DEVICE, the content of which is incorporated herein by reference.

### FIELD OF THE INVENTION

The present invention relates to portable electronic devices. In particular, exemplary embodiments relate to a portable, electronic device that is programmed to assist a user in maintaining a healthy lifestyle.

### BACKGROUND AND SUMMARY OF THE INVENTION

Maintaining a healthy lifestyle is important for numerous reasons. First, it can have a huge impact on the quality of a person's life. People who are healthy tend to be happier, and more successful in day-to-day endeavors. Furthermore, as the life span of individuals continues to grow, leading a healthy lifestyle increases the odds that the later years of life are enjoyable. Second, maintaining a healthy lifestyle can have an impact on the costs of health care. Individuals who are healthy tend to require less medication, less treatment for ailments, less hospital time, etc.

Unfortunately, there are many existing factors that encourage individuals to lead an unhealthy lifestyle. The increasing convenience of many technologies has caused people to be more sedentary than ever before. Teens and adults in particular are spending more and more time in front of televisions and computers and less and less time partaking in healthy activities such as physical exercise. Additionally, hard economic times have made eating relatively inexpensive fast food a more regular event for many people.

Additionally, maintaining a healthy lifestyle requires time and the commitment to accomplish certain health tasks, sometimes on a regular basis. There is a need in the art for a device and system for assisting in the maintenance of a healthy lifestyle. In an exemplary embodiment the present invention comprises a portable, wireless, electronic device that assists an individual in taking a biometric measurement that has been preprogrammed to notify the individual user to engage in a certain health activity. In an exemplary embodiment, the portable, electronic device comprises touch-sensitivity that enables the taking of a biometric measurement. In an exemplary embodiment, the device is programmed to make notifications at certain times. For example, the device may be programmed to sound an alarm when the individual user is supposed to take medication, exercise, eat, take a biometric measurement, sleep, go to see a physician, etc.

In an exemplary embodiment, a portable electronic device comprises a screen for the display of data, graphics, etc. In exemplary embodiments comprising a screen, a portable electronic device assists in the maintenance of a healthy lifestyle by generating graphs from biometric measurement data. In some exemplary embodiments, a portable electronic device comprises a speaker. A speaker of the device may be utilized for sounding instructions to users as to how the portable device is to be used, sounding results of biometric measurements that have been taken, counting down the time remaining until a biometric measurement has been obtained, etc. Some exemplary embodiments of a portable electronic healthcare device comprise means for connecting a user of the device with a remote computerized system. In exemplary embodiments, the remote system is a phone or computer of a health care facility, health care provider, insurance provider, etc. The portable electronic device may comprise a video camera so that once a connection with the remote device has been made, video footage and photographs taken with the camera can be transferred to the remote device.

In some exemplary embodiments, the system of the present invention comprises a portable electronic device and a membership card where the membership card evidences the user's participation in a rewards program and may be utilized to earn and redeem awards. In an exemplary embodiment, the user of the portable electronic device earns reward points in the program for participating in health activities he is notified to perform via the portable electronic device. In some exemplary embodiments, a user of a portable electronic device earns reward points for participating in health activities other than those he is notified to perform via the portable electronic device. In exemplary embodiments, a user of a portable electronic device earns points for health activities he is notified to perform via the portable electronic device and those he is not notified to perform via the portable electronic device.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 shows an exemplary embodiment of the system and method of the present invention.

FIG. 2 shows an exemplary embodiment of a notification schedule of a portable electronic device.

FIG. 3 shows an exemplary embodiment of health devices that may send biometric measurement data to a portable electronic device.

### DETAILED DESCRIPTION

In one exemplary embodiment, the present invention comprises a portable, wireless, electronic device that assists an individual in taking a biometric measurement. In an exemplary embodiment, the invention provides a novel method of taking a biometric measurement through the utilization of a portable, wireless, electronic device. In an exemplary embodiment, the portable, electronic device comprises touch-sensitivity that enables the taking of a biometric measurement. In some embodiments comprising touch sensitivity, merely raising the device and holding it in the palm of a hand enables the device to take a biometric measurement of the individual holding the device. In these exemplary embodiments, the portable device is preferably of a size that it is considered hand-held (i.e., approximately 9-10 inches in diameter or smaller). In other exemplary embodiments, the device comprises a touch-sensitive area, such as a touch pad, that is touched by part of the user's body, such as a finger or wrist, in order to obtain a biometric measurement. In these embodiments, the device may be of hand-held size but it may also be larger than hand-held size. In some exemplary embodiments, a variety of biometric measurements can be taken through the touch sensitivity system of a hand-held portable electronic device of the present invention. In some exemplary embodiments, biometric measurements are taken through palm reading technology of the portable electronic device. Biometric measurements that could be taken through a portable, electronic device comprising touch sensitivity include pulse rate, blood glucose levels, body fat percentage, blood alcohol levels, etc. In some exemplary embodiments, a portable electronic device is not hand-held but still comprises a touch sensitivity system. In one such example, the portable electronic device is approximately the size of a laptop computer and comprises a touch pad where a user places a part of his or her body to utilize the device to obtain a biometric measurement.

In some exemplary embodiments, a portable electronic device may be utilized to take more than one biometric measurement. In an exemplary embodiment, the device comprises touch sensitivity and a single touch of the device by a user enables multiple biometric measurements to be taken. For example, holding the device in the palm of a user's hand could permit the user's blood glucose level and pulse to be taken simultaneously. In some exemplary embodiments where the device comprises touch sensitivity that enables the taking of biometric measurements, the device may be utilized in conjunction with a tool that enables the taking of a biometric measurement that does not utilize the touch-sensitivity of the device. For example, a portable electronic device may be connected to a blood pressure cuff. In another exemplary embodiment, the portable electronic device may be connected to a scale that measures weight. In some exemplary embodiments, a portable electronic device is able to receive a biometric measurement that has been taken with a wireless healthcare device.

In an exemplary embodiment, a portable electronic device comprises a screen for the display of data, graphics, etc. In exemplary embodiments comprising a screen, a portable electronic device assists in the maintenance of a healthy lifestyle by generating graphs from biometric measurement data. In an exemplary embodiment, a portable electronic device obtains a biometric measurement through touch sensitivity, records the measurement in a database, then later retrieves the data from the database, generates a graph with the data and displays the graph on the screen for viewing by the user.

In some exemplary embodiments a portable electronic device comprises a speaker. In an exemplary embodiment, the speaker is used to notify a user when a biometric measurement has successfully been taken with the device. For example, the speaker may emit a beep when the portable device has finished obtaining the user's pulse. A speaker of the device may be utilized for sounding instructions to users as to how the portable device is to be used, sounding results of biometric measurements that have been taken, counting down the time remaining until a biometric measurement has been obtained, etc. In an exemplary embodiment, the speaker sounds an alarm indicating that a health activity is to be performed by the user. The health activity may be the taking of a biometric measurement, taking medication, performing a physical activity (running, sit-ups, physical therapy, etc.), eating, changing the dressings that protect an injury, etc. In some exemplary embodiments comprising a speaker, the speaker comprises ear phones that may be worn by a user.

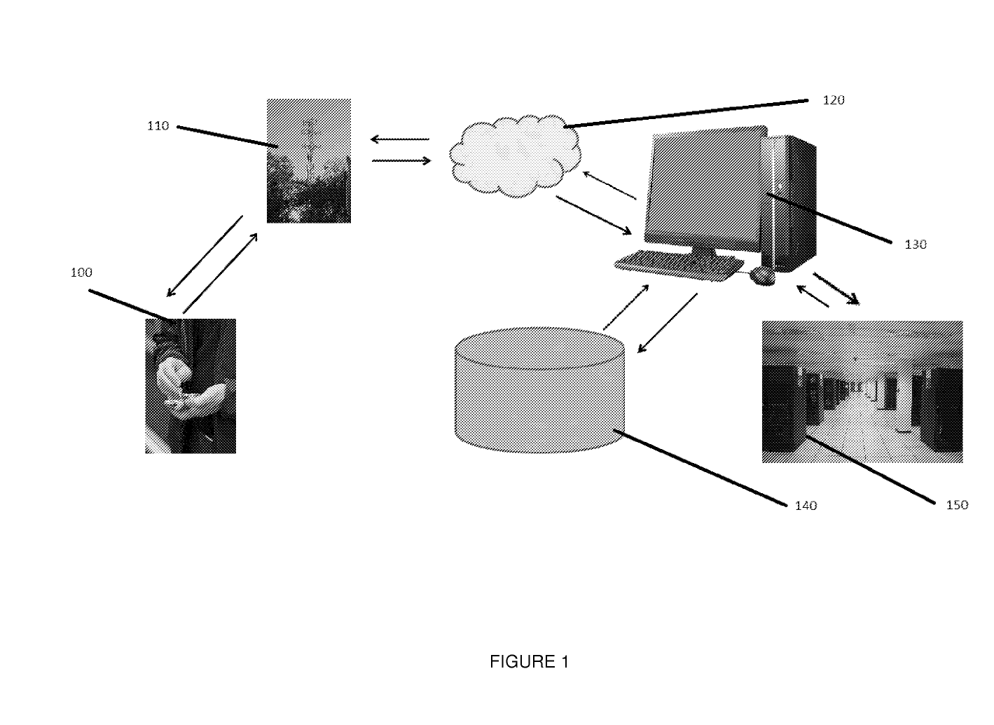

Some exemplary embodiments of a portable electronic healthcare device comprise means for connecting a user of the device with a remote device. FIG. 1 shows an exemplary embodiment of the system and method where an exemplary portable electronic device 100 comprises means for connecting with a remote device 130. In exemplary embodiments the remote device 130 is a phone or computer of a health care facility, health care provider, insurance provider, etc. In an exemplary embodiment, the connecting means comprises a button on the portable electronic device that when pushed, causes a connection with a remote device of the patient's insurance provider to be made. The connection may be carried out through the phone lines, over the Internet, etc. Some exemplary embodiments comprise a means for receiving signals 110 from the portable device 100 and utilize the Internet 120 to make a connection to a remote device 130. In exemplary embodiments comprising a connection means, connecting to the remote device does not require the portable electronic device to be physically connected to any external drives, wires, etc. In another exemplary embodiment, the portable electronic device comprises a touch-sensitive screen. In this exemplary device, touching an emblem displayed by the screen may connect the user of the device to the remote device. The portable electronic device may comprise software enabling communication with the remote device. In exemplary embodiments, a remote device 130 comprises a computer that is in communication with a server 150 and a database 140.

The portable electronic device may comprise a video camera so that once a connection with the remote device has been made, video footage and photographs taken with the camera can be transferred to the remote device. In one exemplary embodiment comprising a video camera, the portable device may comprise a video-conference generation means. A video-conference generation means may comprise a button that when pushed causes the video camera to begin generating images that are then transferred to a remote device over a connection that has been made.

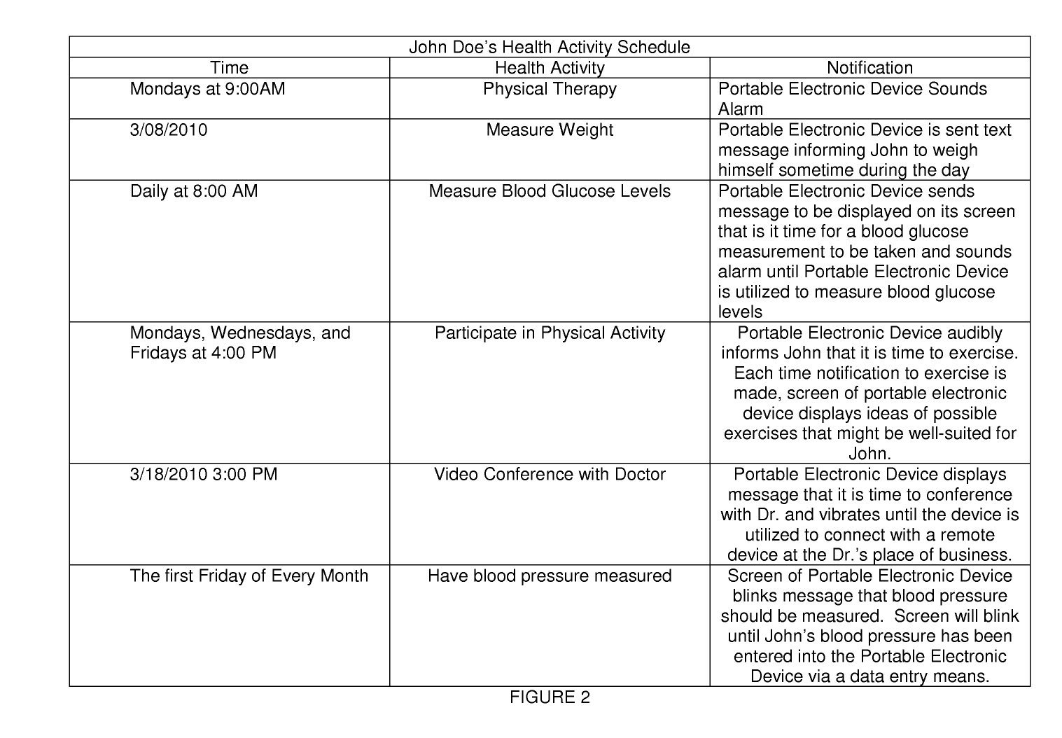

In an exemplary embodiment, a portable electronic device has been preprogrammed for an individual user in order to assist the user in maintaining a healthy lifestyle. In an exemplary embodiment where a portable electronic device has been pre-programmed for an individual user, the device has been programmed to notify the user to perform a certain health task. In an exemplary embodiment, the device is programmed to make notifications at certain times. Exemplary embodiments utilize a notification schedule. FIG. 2 shows an exemplary embodiment of a notification schedule of the present invention. For example, the device may be programmed to sound an alarm when the individual user is supposed to take medication, exercise, eat, take a biometric measurement, sleep, go to a physician's appointment, etc. The portable electronic device may have multiple alarms to accommodate notifications corresponding to different activities. In some exemplary embodiments, a portable electronic device may also notify a user to perform a certain task that does not comprise a health task. In an exemplary embodiment, a portable electronic device is pre-programmed to notify a user to perform a set of health tasks but once the user receives the portable device he or she can add additional notifications.

In an exemplary embodiment, the system comprises memory for storing health activity and other data in one or more databases. In an exemplary embodiment, the database is located within memory in the portable electronic device. In another exemplary embodiment, the database is located at a device that is remote from the portable electronic device. A notification schedule may be stored in the database where the notification schedule comprises date or time data and corresponding activity data. Date or time data may comprise a date or time of day the user is to be notified to perform a health activity. The corresponding activity data may comprise data indicating the health activity the user is supposed to perform. In an exemplary embodiment, the portable electronic device monitors the date and time data of the notification schedule and compares it to the current date and time. When the current date and time matches the date and time criteria of the notification schedule the portable electronic device notifies the user. In an exemplary embodiment, the portable electronic device causes corresponding activity data to be displayed by a screen of the portable electronic device at the appropriate time of notification.

In an exemplary embodiment of a portable electronic device that has been preprogrammed for an individual, the device provides an appropriate maintenance program for the individual. For example, the device may be programmed to sound a daily alarm at 8 AM and alert the user that it is time to take a certain medication, and also to remind the user that the medication should not be taken on an empty stomach. In some exemplary embodiments the reminder is displayed by a screen of the device but the reminder may be provided through a speaker in some embodiments. In some exemplary embodiments, a notification alarm sounds at certain intervals (every 10 minutes for example) until the device has been notified that the health activity at issue has been performed. In some exemplary embodiments, a button may be pushed to notify the portable electronic device that the health activity has been performed. In other exemplary embodiments the health activity is the taking of a biometric measurement that is taken with the device and the act of taking the measurement informs the portable device that the health activity has been performed. In another exemplary embodiment, a portable electronic device receives data from a wireless healthcare device where the receipt of data informs the device that a healthy activity has been completed. The device, therefore, may be used to track completion of health activities.

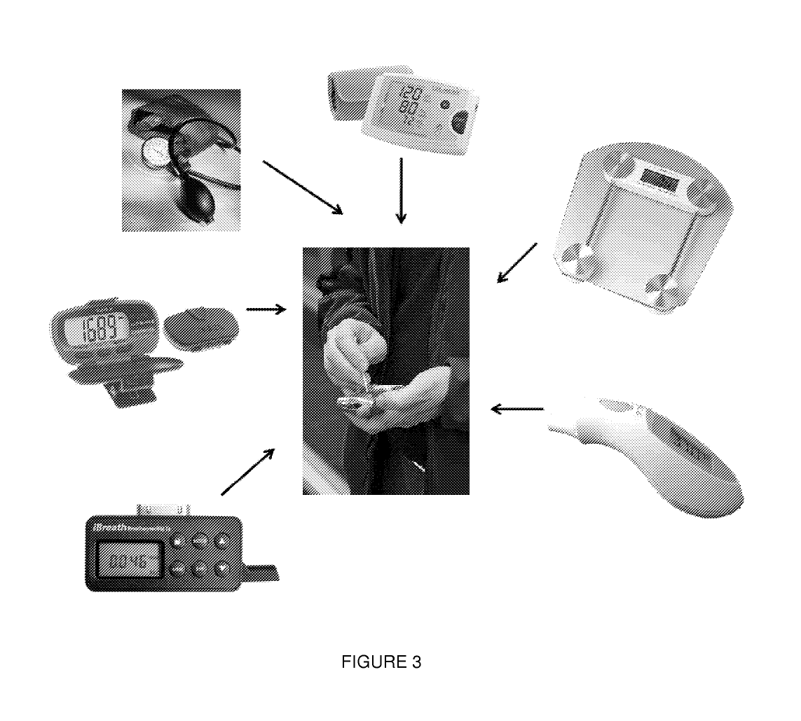

FIG. 3 shows an exemplary embodiment of health devices that may be utilized to send health activity data to a portable electronic device. In some exemplary embodiments, a message may be sent from a remote device 130 to notify the portable electronic device that a health activity has been completed. For example, the healthy activity at issue may be going to a physician's appointment. In this example, a signal from a portable electronic device belonging to the physician may be received by the portable electronic device of the user indicating that the user has met with the physician. In another example, the remote device 130 is the physician's computer. The physician may enter data such as a code that is used to update the portable electronic device. A user of a portable electronic device may be able to access a website on a remote device 130 in order to update his or her portable electronic device 100 or receive updates originating from a third party.

In another exemplary embodiment, the portable electronic device may comprise a data entry means. A data entry means may comprise a key pad or a touch screen. In an exemplary embodiment comprising a data entry means, the data entry means can be utilized to enter a code into the portable electronic device. Each activity may have a field or completion indicator associated with it to record completion data. In such a portable electronic device, utilizing the data entry means to enter a code may inform the portable electronic device that a health activity has taken place. Codes according to the present invention facilitate tracking of activities and increase compliance through third-party validation. For example, a physician may have a certain code that he or she enters into the portable electronic device of a user when the user comes for an appointment with the physician. In another exemplary embodiment, a health activity may be calling the user's insurance provider. Once the user has called the insurance provider, the insurance provider may give the user a code that he or she may then enter into the portable electronic device to inform the device that the health activity has occurred. If the user visits a health club on a regular basis, a health club representative may provide a code for the user to enter to inform the device that the health activity has occurred. The user may be reminded or notified of certain activities until appropriate completion data is entered.

In exemplary embodiments, a portable electronic device may be updated. In some exemplary embodiments, a portable electronic device can be updated for an individual user from a remote location. For example, the physician of a user of a portable electronic device may be able to update that user's device by logging into a website and entering completion codes and other updates. The updates may indicate that the user has completed a health activity such as a doctor's appointment or test as well as schedule data for another appointment or test. The website may then transfer the updates to a database. The database may be a database monitored by the portable electronic device. In another exemplary embodiment, the database is not a database monitored by the electronic device. When the updates have been entered remotely into a database that is not monitored by the portable electronic device, a program running at a server may monitor for the updates and upon their detection, cause the updates to be sent to a database that is monitored by the portable electronic device. Updates for a user may comprise notifications, health information, medication information, health statistics, appointment information, completion data, etc. In some exemplary embodiments a portable electronic device obtains updates by being connected to a computer in connection with a database that houses the updates where the updates are uploaded through the computer.

In some exemplary embodiments, a preprogrammed portable electronic device provides appropriate maintenance for a user by enabling connections to the user's healthcare facility, healthcare provider, insurance provider, etc. In one exemplary embodiment, engaging a connection means of the portable electronic device immediately connects the portable device with the remote device of the user's healthcare provider. For example, pushing a button on the portable electronic device may connect the user to the phone or computer of a Personal Nurse for a consult. In another exemplary embodiment, pushing a button on the portable electronic device could arrange for a video-conference with the user's doctor allowing the doctor to visually inspect the user for symptoms of illness, etc. In some exemplary embodiments a connection means comprises an emblem on a touch screen.

In an exemplary embodiment where engaging a connecting means of a portable electronic device causes a video-conference to be arranged, a video conference could be immediately initiated with a remote device upon engagement. The portable electronic device may be preprogrammed so that a connecting means of the device corresponds to a specific remote device that is relevant to the health of the user. For example, a connecting means may be programmed to connect the portable electronic device with the physician's office of the user. In some exemplary embodiments, a video-conference is arranged by sending a request from the portable electronic device to a remote device to initiate or schedule a video conference with the portable electronic device.

In some exemplary embodiments, the portable electronic device comprises a screen and the device notifies an individual to perform a certain task by presenting text on the screen where the text tells the user what he or she is supposed to be doing. For example, a screen of the portable device may display a message for the individual user indicating he or she needs to take a blood sugar measurement. In exemplary embodiments comprising a screen and where the portable device notifies an individual user to perform a task (whether via the screen or through another notifying means such as sounding an alarm), the screen may be utilized to present a message for the user that coordinates with the task. For example, if the user is being notified to partake in exercise the screen may display a message indicating how the exercise will benefit the user. If the user is being notified to take a certain medicine, the message may contain information about the medication the user is supposed to take (dosage information, side effect information, etc.). If the user is being notified to take a biometric measurement, the message may contain information about the desired biometric measurement, healthy measurements, unhealthy measurements, etc.

In some exemplary embodiments, the system of the present invention comprises a portable electronic device and a membership card where the membership card evidences the user's participation in a rewards program and may be utilized to earn and redeem awards. In some exemplary embodiments the card may not necessarily be utilized to earn and redeem awards of the rewards program. In an exemplary embodiment, the user of the portable electronic device earns reward points in the program for participating in health activities he is notified to perform via the portable electronic device. In some exemplary embodiments, a user of a portable electronic device earns reward points for participating in health activities other than those he is notified to perform via the portable electronic device. In exemplary embodiments, a user of a portable electronic device earns points for health activities he is notified to perform via the portable electronic device and those he is not notified to perform via the portable electronic device.

In some exemplary embodiments, a user of a portable electronic device receives reward points by participating in a health activity and then presenting his or her membership card to an entity capable of reporting the occurrence of the health activity. In an exemplary embodiment comprising a program administrator for the rewards program, points may be rewarded to the user by reporting health activities to the administrator. For example, a program administrator of an exemplary embodiment of a rewards program of the present invention may be an insurance provider. Reporting the health activities of a portable electronic device user to the administrator insurance provider may cause the user to receive reward points. Many types of entities may be program administrators and in some exemplary embodiments, a program administrator is comprised of multiple legal entities.

In some exemplary embodiments of a rewards program of the present invention, a user of a portable electronic device earns rewards points in the program by participating in a variety of health activities. For example, rewards points may be rewarded for establishing an HRA, having an annual mammography, having an annual colonoscopy, agreeing to accept generic rather than brand name drugs, buying certain products, frequent gym visits, etc. In an exemplary embodiment, a user of a portable electronic device also receives reward points for non-health activities that may include things like waiving the right to a paper statement that would otherwise have been received from a service provider, birthdays (the user may receive free points on his or her birthday), holidays, engaging in business with certain retailers or service providers, etc.

In some exemplary embodiments a user of a portable electronic device may utilize the portable electronic device to monitor points he or she has been awarded in a rewards program of the present invention. In an exemplary embodiment, a user utilizes their portable electronic device to access a database where his or her rewards point activity is being stored. In some exemplary embodiments, the rewards points of a user are stored in an account that spans multiple legal entities. In some embodiments, the account storing rewards points for health activities may also store reward points for non-health activities such as financial activities. In an exemplary embodiment where rewards points are stored in an account, the portable electronic device may be utilized to access the account.

In one example, a user may access a website to review his or her reward point activity. Reward point activity may comprise information as to the date a user participated in a health activity, the health activity that was performed, the number of reward points awarded for the health activity, etc. In another example, a user may dial a telephone number to access his or her reward point activity. In yet another example, a user receives a statement of reward point activity. The statement may be electronic but could also be a paper statement. In an exemplary embodiment, there are a variety of ways a user of a portable electronic device may monitor his or her rewards points.

In some exemplary embodiments, a rewards program of the present invention rewards points to both users of a portable electronic device as well as to individuals who do not utilize a portable electronic device. In an exemplary embodiment where an individual who does not utilize a portable electronic device earns reward points, points may be rewarded to the individual upon presentment of his or her membership card after he or she has engaged in a health activity. In an exemplary embodiment, a rewards program assigns membership numbers to program participants. In exemplary embodiments where membership numbers are assigned, the membership card of a participant may comprise his or her membership number. In some exemplary embodiments, a membership number is utilized to reward points to a program participant.

An exemplary embodiment comprises a database for storing reward point activity. The database may be in communication with a server that is in communication with a remote computer. In an exemplary embodiment, a rewards program participant utilizes the remote computer to send a request to the server to view his or her reward point data. Upon receiving the request at the server, the server may access the database, retrieve the requested data, and send the data to the remote computer for viewing. In an exemplary embodiment, the user must enter identifying information into the remote computer before he or she has access to rewards point data. Some exemplary embodiments comprise a website.

While certain embodiments of the present invention are described in detail above, the scope of the invention is not to be considered limited by such disclosure, and modifications are possible without departing from the spirit of the invention as evidenced by the claims. For example, the types of measurements taken by the device may be varied and fall within the scope of the claimed invention. Other aspects of data collection and communication to an insurance provider may be varied and fall within the scope of the claimed invention. Aspects of the rewards program may be varied and fall within the scope of the claimed invention. One skilled in the art would recognize that such modifications are possible without departing from the scope of the claimed invention.

1. A computerized method for tracking health activity using a preprogrammed portable health device comprising:
(a) assigning at a server a service provider completion code corresponding to a health activity;
(b) transmitting from said server to a user's preprogrammed portable health device health activity data comprising:
(1) a description of said health activity to be performed by said user;
(2) a date or time for completing said health activity; and
(3) a completion code field for receiving said service provider completion code;
(c) upon completion of said health activity, receiving at said user's preprogrammed portable health device said service provider completion code, said service provider completion code:
(1) transmitted to said user's preprogrammed portable health device from a service provider device; and
(2) automatically received in said completion code field;
(d) receiving at said server from said user's preprogrammed portable health device:
(1) said description of said health activity; and
(2) said service provider completion code indicating completion of said health activity; and
(e) verifying at said server for said user completion of said health activity using said service provider completion code as a completion indicator.

2. (canceled)

3. The computerized method of claim 1 wherein said service provider completion code associated with completion of said health activity is received at said user's preprogrammed portable health device from a wireless portable device of said service provider.

4. The computerized method of claim 1 wherein said service provider completion code is received from a remote computer of said service provider in communication with said user's preprogrammed portable health device.

5. (canceled)

6. The computerized method of claim 1 wherein said service provider is selected from the group consisting of:
a health care services provider, an insurance provider, and health care facility representative.

7. The computerized method of claim 1 wherein said health activity is selected from the group consisting of:
taking a biometric measurement, taking a medication, attending a health provider appointment, and visiting a health club.

8. The computerized method of claim 1 further comprising:
(f) receiving at said server from a user computer a request to access said health activity data.

9. The computerized method of claim 1 further comprising:
(f) connecting said preprogrammed portable health device telephonically to a health care professional in response to selection of a button on said portable device.

10. A preprogrammed portable health device for tracking health activity comprising:
(a) a memory component for storing health activity data wherein said health activity data comprises:
(1) a description of a health activity to be performed by a user of said preprogrammed portable health device;
(2) a date or time for completing said health activity; and
(3) a completion code field; and
(b) a data entry component for:
(1) upon completion of said health activity, receiving at said preprogrammed portable health device a service provider completion code assigned to said health activity to indicate completion of said health activity; and
(2) recording said service provider completion code in said completion code field of said health activity.

11. The preprogrammed portable health device of claim 10 wherein said service provider completion code associated with completion of said health activity is entered by said user.

12. The preprogrammed portable health device of claim 11 wherein said service provider completion code associated with completion of said health activity is received by said user from a third party.

13. The preprogrammed portable health device of claim 10 wherein said service provider completion code is received from a remote server in communication with said device.

14. The preprogrammed portable health device of claim 13 wherein said service provider completion code is received from a remote server of a third party that enters said completion code on behalf of said user.

15. The preprogrammed portable health device of claim 10 wherein said health activity is selected from the group consisting of:
taking a biometric measurement, taking a medication, attending a health provider appointment, and visiting a health club.

16. The preprogrammed portable health device of claim 10 further comprising a remote connection means for connecting said preprogrammed portable health device to a remote system, transmitting said health activity data comprising said service provider completion code from said preprogrammed portable health device to said remote system, and receiving at said remote system from a user computer a request to access said health activity data.

17. A computerized method for tracking health activity using a preprogrammed portable health device comprising:
(a) storing at a server health activity data and service provider completion code data associated with said health activity data to indicate completion of said health activity;
(b) transmitting from said server to a service provider's remote server said health activity data and said service provider completion code data;
(c) receiving at a preprogrammed portable health device of a user performing a health activity:
(1) said health activity data
(2) a date or time for completing said health activity; and
(3) a completion indicator;
(d) upon completion of said health activity, receiving at said preprogrammed portable health device from said service provider's remote server said service provider completion code data associated with said health activity data; and
(e) recording said service provider completion code data in said completion indicator of said preprogrammed portable health device.

18. The computerized method of claim 17 wherein said service provider completion code data is received from a service provider selected from the group consisting of:
a health care services provider, an insurance provider, and health care facility representative.

19. The computerized method of claim 17 wherein said health activity is selected from the group consisting of:
taking a biometric measurement, taking a medication, attending a health provider appointment, and visiting a health club.

20. The computerized method of claim 17 further comprising:
(d) transmitting said health activity data from said preprogrammed portable health device to a server; and
(e) receiving at said server from a user computer a request to access said health activity data.
